(19) United States
(12) Patent Application Publication
(10) Pub. No.: US 2011/0090635 A1
(43) Pub. Date: Apr. 21, 2011

(54) HARD DISK MOUNTING DEVICE

(75) Inventors: LEI LIU, Shenzhen City (CN); XIAO-ZHU CHEN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/641,205

(22) Filed: Dec. 17, 2009

(30) Foreign Application Priority Data
Oct. 20, 2009 (CN) 200910308518.0

(51) Int. Cl. G06F 1/16

(52) U.S. Cl. 361/679.33

(57) ABSTRACT

A hard disk mounting device includes a receiving portion. The receiving portion includes a bottom plate and two side plates vertically extending from opposite sides of the bottom plate. The bottom plate and the side plates bound a space to selectively accommodate at least one first size hard disk and a second size hard disk. At least one first fixing mechanism formed in the receiving portion to mount the at least one first size hard disk, and a second fixing mechanism formed in the receiving portion to mount the second size hard disk.

### BACKGROUND

1. Technical Field

The present disclosure relates to a hard disk mounting device.

2. Description of Related Art

Hard disks are usually fixed in a hard disk mounting device to be installed in a server or a computer. However, by conventional methodology, one kind of hard disk mounting devices is used to fix only one kind of hard disks, such as a 3.5-inch hard disk mounting device for fixing a 3.5-inch hard disk only, a 2.5-inch hard disk mounting device for fixing a 2.5-inch hard disk only.

### BRIEF DESCRIPTION OF THE DRAWINGS

FIG. 1 is an assembled, isometric view of an exemplary embodiment of a hard disk mounting device.

FIG. 2 is an exploded, isometric view of a 2.5-inch hard disk module, and the hard disk mounting device of FIG. 1.

FIG. 3 is an assembled view of FIG. 2.

FIG. 4 is an exploded, isometric view of a 3.5-inch hard disk module, and the hard disk mounting device of FIG. 1.

FIG. 5 is an assembled view of FIG. 4.

### DETAILED DESCRIPTION

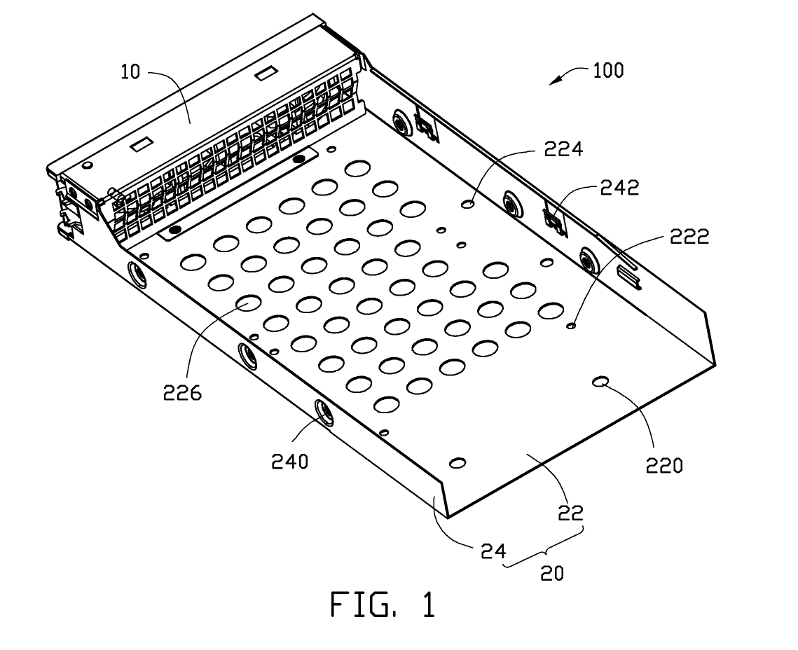

Referring to FIG. 1, an exemplary embodiment of a hard disk mounting device 100 capable of selectively fixing a 2.5-inch hard disk module or a 3.5-inch hard disk module includes a connecting portion 10 and a receiving portion 20.

The receiving portion 20 is generally U-shaped and includes a bottom plate 22 and two side plates 24 extending vertically from opposite sides of the bottom plate 22. The connecting portion 10 is positioned to a first end of the bottom plate 22. A second end of the bottom plate 22 opposite to the first end defines two fixing holes 220, and the two fixing holes 220 are aligned perpendicularly to the two side plates 24. The bottom plate 22 forms two first fixing mechanisms each adjacent to the two side plates 24. Each first fixing mechanism includes four fixing holes 222 defined in the bottom plate 22. Two fixing holes 222 of four fixing holes 222 are adjacent to one of the side plates 24, and the other two fixing holes 222 are adjacent to the other side plate 24. The receiving portion 20 further forms a second fixing mechanism. The second fixing mechanism includes four fixing holes 224 defined in the bottom plate 22 and a plurality of fixing holes 240 symmetrically defined in the opposite side plates 24. The four fixing holes 224 are between the side plates 24 and the corresponding fixing holes 222. The bottom plate 22 further defines a plurality of ventilation holes 226 for heat dissipation. Two elastic tabs 242 extend inward from one side plate 24.

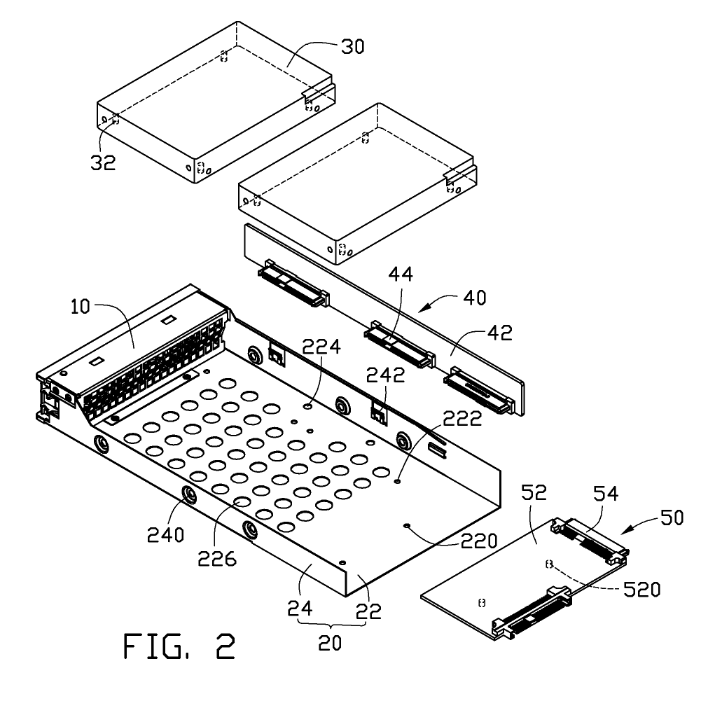

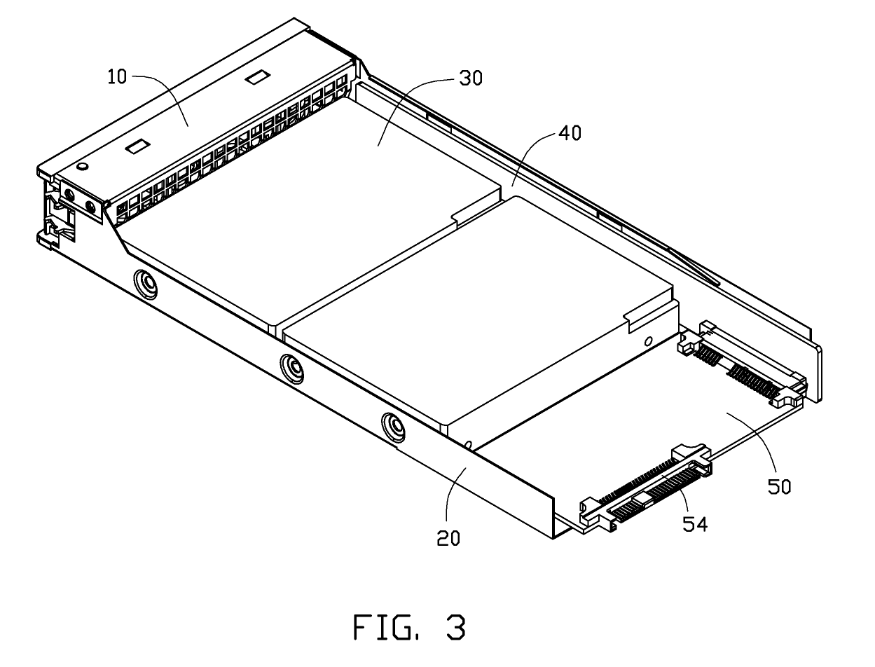

Referring to FIGS. 2 and 3, the 2.5-inch hard disk module includes two 2.5-inch hard disks 30, a first adapter card 40, and a second adapter card 50. Each 2.5-inch hard disk 30 defines an interface (not shown), and four screw holes 32 in the bottom. The first adapter card 40 includes a circuit board 42, and three connectors 44 linearly arranged on one side of the circuit board 42. The three connectors 44 are all serial attached small computer system interface (SCSI, SAS) female header connectors. The second adapter card 50 includes a circuit board 52. Two connectors 54 are formed on a side and an end of the circuit board 52 correspondingly. Each connector 54 is an SAS male header connector. The bottom of the circuit board 52 defines two screw holes 520, corresponding to the two fixing holes 220 of the bottom plate 22 of the receiving portion 20.

In assembly, the interfaces of the 2.5-inch hard disks 30 are correspondingly inserted into two adjacent connectors 44 of the first adapter card 40, and the connector 54 at the side of the second adapter card 50 is inserted into the idle connector 44 of the first adapter card 40. The 2.5-inch hard disk module is placed in the receiving portion 20. The two elastic tabs 242 of the side plate 24 resist against another side of the circuit board 42 of the first adapter card 40 opposite to the connectors 44, to buffer and fix the first adapter card 40. A plurality of screws (not shown) are passed through the fixing holes 222 and engaged in the screw holes 32 of the bottoms of the 2.5-inch hard disks 30, to fix the 2.5-inch hard disks 30 to the bottom plate 22. Two screws (not shown) are passed through the fixing holes 220 and engaged in the two screw holes 520 of the second adapter card 50, to fix the second adapter card 50 to the bottom plate 22. The 2.5-inch hard disk module may be installed in a server or a computer by the connecting portion 10, and electrically connects with the computer or the server by the connector 54 at the end of the second adapter card 50.

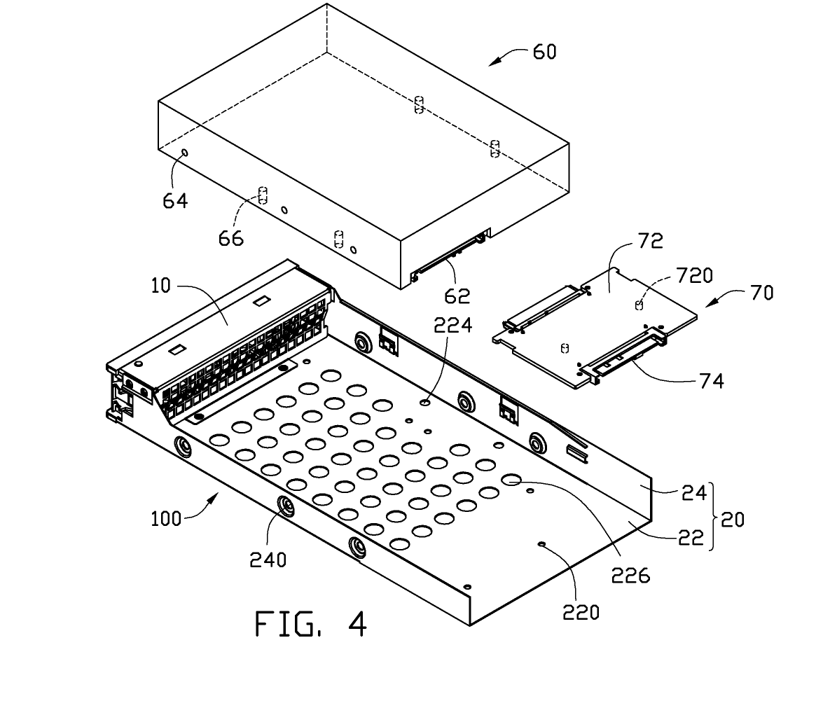

Referring to FIG. 4, the 3.5-inch hard disk module include a 3.5-inch hard disk 60 and an adapter card 70. One end surface of the 3.5-inch hard disk 60 defines an interface 62, two opposite side surfaces of the 3.5-inch hard disk 60 respectively define three screw holes 64, and a bottom of the 3.5-inch hard disk 60 defines four screw holes 66. The adapter card 70 includes a circuit board 72. Two connectors 74 are formed on opposite sides of the circuit board 72. The connectors 74 are SAS male header connectors. A bottom of the circuit board 72 defines two screw holes 720 corresponding to the two fixing holes 220 of the bottom plate 22 of the receiving portion 20.

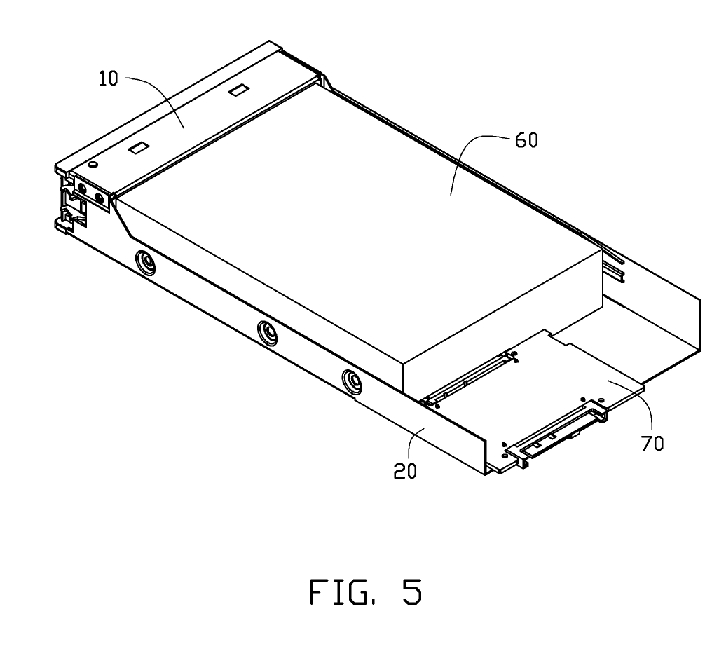

Referring to FIG. 5, in assembly, the interface 62 of the 3.5-inch hard disk 60 is inserted into one connector 74 of the adapter card 70. The 3.5-inch hard disk module is placed in the receiving portion 20. A plurality of screws (not shown) are passed through the fixing holes 240 and engaged in the screw holes 64 of the two side surfaces of the 3.5-inch hard disk 60, thereby fixing the 3.5-inch hard disk 60 to the receiving portion 20. Two screws (not shown) are passed through the fixing holes 220 and engaged in the two screw holes 720 of the adapter card 70, to fix the adapter card 70 to the bottom plate 22. The 3.5-inch hard disk module may be installed in a server or a computer by the connecting portion 10, and electrically connects with the computer or the server by the other connector 74 of the adapter card 70.

In other exemplary embodiments, a plurality of screws (not shown) are capably passed through the fixing holes 224 and engaged in the screw holes 66 of the bottom of the 3.5-inch hard disk 60, and a plurality of screws are passed through the fixing holes 240 and engaged in the screw holes 64, to fix the 3.5-inch hard disk 60 to the receiving portion 20.

It is to be understood, however, that even though numerous characteristics and advantages of the present disclosure have been set forth in the foregoing description, together with details of the mechanism and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hard disk mounting device comprising:
a receiving portion comprising a bottom plate and two side plates vertically extending from opposite sides of the bottom plate; wherein the bottom plate and the side plates bound a space to selectively accommodate at least one first size hard disk and a second size hard disk;
at least one first fixing mechanism formed in the receiving portion to mount the at least one first size hard disk; and
a second fixing mechanism formed in the receiving portion to mount the second size hard disk.

2. The hard disk mounting device of claim 1, further comprising a first adapter card and a second adapter card mounted to the receiving portion, wherein the first adapter card comprises a first circuit board and two or more first connectors arranged on and electrically connected to the circuit board, the second adapter card comprises a second circuit board and two second connectors, a corresponding number of the adjacent first connectors is operable to engage with the at least one first size hard disk, at least one first connector is not engaged with any first size hard disk, one of which is connected to one of the second connectors, the other second connector is operable to function as a connector of the hard disk mounting device.

3. The hard disk mounting device of claim 2, wherein an end of the bottom plate defines a plurality of fixing holes to fix the second adapter card.

4. The hard disk mounting device of claim 2, wherein the number of the two or more first connectors is three, the number of at least one first size hard disk is two, the at least one fixing mechanism comprises two first fixing mechanisms, each first fixing mechanism comprises a plurality of fixing holes defined in the bottom plate, to fix the first size hard disks.

5. The hard disk mounting device of claim 4, wherein one side plate defines two elastic tabs to buffer and fix the first adapter card.

6. The hard disk mounting device of claim 2, wherein the first connectors of the first adapter card are all serial attached small computer system interface female header connectors.

7. The hard disk mounting device of claim 2, wherein the second connectors of the second adapter card are both serial attached small computer system interface male header connectors.

8. The hard disk mounting device of claim 1, further comprising an adapter card mounted to the receiving portion, wherein the adapter card comprises a circuit board and two connectors electrically connected to the circuit board, a connector of the adapter card is operable to engage with the second size hard disk, the other connector of the adapter card is operable to function as a connector of the hard disk mounting device.

9. The hard disk mounting device of claim 8, wherein the second fixing mechanism comprises a plurality of fixing holes symmetrically opposite defined in the side plates, to fix the second size hard disk.

10. The hard disk mounting device of claim 8, wherein the second fixing mechanism comprises a plurality of fixing holes a plurality of fixing holes defined in the bottom plate, to fix the second size hard disk.

11. The hard disk mounting device of claim 8, wherein an end of the bottom plate defines two fixing holes, to fix the adapter card.

12. The hard disk mounting device of claim 8, wherein the connectors of the adapter card are both serial attached small computer system interface male header connectors.
